(19) United States
(12) Patent Application Publication
(10) Pub. No.: US 2005/0010486 A1
(43) Pub. Date: Jan. 13, 2005

(54) A system and a method for adding a desired product item from an internet based online store to an internet based universal product item registry

(75) Inventor: Rahul Ramakant Pandhe, Union City, CA (US)

Correspondence Address: GIFTWISDOM, 1877 FIREBRICK TERRACE, UNION CITY, CA, 94587, US

(73) Assignee: GIFTWISDOM, Union City, CA (US)

(21) Appl. No.: 10/709,888

(22) Filed: Jun. 3, 2004

Related U.S. Application Data
(60) Provisional application No. 60/485,231, filed on Jul. 7, 2003.

(51) Int. Cl. G06F 17/60

(52) U.S. Cl. 705/26

(57) ABSTRACT

The invention relates to electronic commerce and specifically to a method of adding desired product from various online stores to a single online third-party universal product registry used to provide services such as online gift registries, wish lists and online product catalogs. Prevalent techniques to add product information from any online store to a single registry has following deficiencies: 1. Precise information of the product e.g. image, price, and description cannot be captured. 2. To get this precise information, it requires software-programming integration with every online store making it impractical. This also necessitates the use of prime real estate on every merchant store, which they may not offer. The invention solves these deficiencies with a small software that works in conjunction with prevalent Internet Browsers by providing a simple one-click interface on the product image to record the image, description and price of the product to a single registry.

### BACKGROUND OF INVENTION

The present invention relates to electronic commerce and more specifically to a method of selecting and adding desired product items to internet based universal product item registries that are used to provide services such as online gift registries, online personal wish lists and internet based product item catalogs and in the online purchase of product items specified in such product item registries.

The internet based gift registry service is an example of a related art that uses categorized product item lists to describe the product items that are of interest to a gift recipient. In such a system, a gift recipient creates a gift registry at the internet site operated by a gift registry service provider. The gift registry comprises of one or more product item lists that enumerate and describe the various product items that the gift recipient desires to receive for a certain event, such as a wedding, a college graduation or a birthday celebration. Typically the description of individual products in such an enumerated list of product items consists of the product's name and manufacturer, product's price information along with any discount offers that may be available with the purchase of that product and the one or more Uniform Resource Locators (URL), which define the internet addresses of the online retailers that sell the said product. The relatives and friends of the gift recipient can then gain access to this gift registry by accessing the internet site hosting this gift registry and purchase one or more of the product items listed in the registry. A gift registry system such as this is beneficial to both the gift recipient and also to the gift giver. It enables the gift recipients to express their needs and desires in clear descriptive product item lists and it allows the gift givers to purchase items that are really desired and needed by the gift recipient rather than guessing the nature and kind of gifts that would fulfill the recipient's needs and desires.

Another related art example that uses categorized product item lists is the online wish list service provided by internet based online stores or internet based independent third party wish list service providers. A typical internet based wish list system is designed to capture the needs and desires of internet shoppers by enabling such shoppers to create one or more lists of product items that they would be interested in purchasing at some future time. To use such a wish list system, a shopper typically creates a wish list account at the internet site operated by an online store or at a third party wish list service provider. After creating a wish list account, whenever this shopper comes across a product item at any online store that he or she would like to purchase at some future date, the shopper can add the pertinent details about such product items to the product item wish list associated with his or her wish list account. The product details typically consist of information such as the product description, its selling price, the manufacturer and brand name of the product, the name and Uniform Resource Locator of the online stores selling the product, special offers that may be available with the purchase of the desired product, etc. Moreover, certain online stores may also choose to offer their own store specific wish list service. In such a store specific wish list service, the shoppers after creating a wish list account can select product items from the online store that they would like to purchase at a future date and add the details of the selected product items to their wish list which is maintained by the online store. Typically, such online stores that offer wish list services provide convenient usability features on the store's website such as a graphical button or an internet hyperlink or such other means to enable shoppers to conveniently specify the product items that they would like to add to their wish list. In addition, some online stores that have business relationships with an independent third party wish list service provider can choose to provide similar convenient graphical features or internet hyperlinks on their websites thereby enabling shoppers to directly add descriptions of product items available at the online store to the their wish list hosted and maintained by the said independent third party wish list service provider.

The prior art method of adding desired product items to gift registries and personal wish lists has inherent limitations and drawbacks. Gift registry services and wish list services that are offered by online stores, either directly or through third party independent service providers, limit the shopper's choice of product items to only the set of product items that are sold by the online retailer offering the service or to a small group of online retailers who may have come together to provide a common gift registry or wish list service. In addition, to improve usability of the gift registry or wish list service offered by the online store, such stores often have to provide one or more graphical interfaces and internet hyperlinks on their internet site to enable shoppers to conveniently select the products that they would like to add to the product item list in their gift registry or wish list. While such graphical interfaces and internet hyperlinks assist the shoppers in adding the desired product item lists to their gift registry or wish list, they tend to take up premium display area on the online store's internet web site and thus restrict the number of distinct gift registry or wish list service providers that the online store can support. In addition, online stores that provide such gift registry or wish list services, either directly or through a third party service providers, incur additional information technology related design, engineering and maintenance costs in order to provide integrated support for such services from the store's web site.

Furthermore, shoppers at online stores that do not provide adequate support for creating and adding product items to gift registries or wish lists, have to typically open an account with an independent gift registry service provider or wish list service provider and then manually create and populate the product item list by individually adding the name and pertinent details of the desired product items into this list. This is a often a difficult and error prone proposition because shoppers would often leave out certain critical pieces of information required to identify a particular product, such as the product's brand name, the internet address of the online store selling that product, any special offers that might be available with that product, etc. Some independent registry service providers do provide internet browser based add-on features such as a tool bar button to help the shoppers in adding a desired product item to their registry. By activating such a tool bar button, shoppers can add to their registry the Uniform Resource Locator of the web page of the online store that contains the listing of the desired product item. Such features however, fail to provide an adequate solution in situations where the web page contains a listing of more than one product items because the shopper's choice of a particular product item cannot be determined by following the referenced the Uniform Resource Locator of such a web page.

As evident from the prior art examples described above, there appears to be a distinct need to provide the online shoppers with an easy and convenient method of adding desired product items to universal product item lists. Such universal product item lists overcome the limitation of traditional wish lists that limit shoppers' choice to product items available only at a particular online store or a group of online stores but instead enable online shoppers to select product items available at any of the large number of online stores on the internet. Similarly, when universal product item lists are used in online gift registries, they enable gift registrants to select product items from any of the numerous online stores on the internet and add the desired product item to the product item list associated with their gift registry.

The object of the present invention is to address the limited scope of the prior art examples described above and to fulfill the need for an easy and convenient method of adding the desired product items to universal product item registries that leverage the universality of the internet and overcome the limitations of conventional online gift registries and online wish list services that restrict the shopper's choice of product items to only those product items that are available in a particular online store or in a small group of closely linked online stores that may come together to provide the gift registry or the wish list service.

### SUMMARY OF INVENTION

An exemplary embodiment is a system and method for electronic network based commerce that enables online shoppers to select a desired product item and conveniently add pertinent information about the selected product item such as the product's name, selling price, manufacturer name, etc. to one or more product item lists associated with one or more universal product item registry accounts. In such an embodiment, the online shopper would typically use a single click action of the computer mouse, keyboard or such other input device to select the desired product item and indicate the desire to add the selected product item to one or more product item lists associated with one or more universal product item registry accounts, upon which the system determines the pertinent information about the selected product item by either parsing the web page of the online store or by querying one or more computer databases maintained by the online store operator and then inserts the product item information thus obtained into one or more product item lists associated with one or more universal product item registry accounts. Universal product item registries can be used to provide online shoppers with services such as an online gift registry service, online product item catalogs, etc. In addition, universal product item registries can also help capture the needs and desires of shoppers by providing services such as an online wish list service that shoppers can use to list and describe product items that are of interest to them and the product items that they desire to own at some future date.

### BRIEF DESCRIPTION OF DRAWINGS

FIG. 1 illustrates the sequence of steps that a typical gift registrant user undertakes to setup a client device to use a universal gift registry service that employs the present invention.

FIG. 2 illustrates the aspect of the present invention that enables a gift registrant user to add pertinent details about a desired product item to the product item list asssociated with the user's online gift registry account. In this figure, the gift registrant user has a gift registry account with “GiftWisdom”, which is an online gift registry service that implements an embodiment of the present invention. After setting up the client device such as a personal computer, with the necessary software systems as described in FIG. 1, the user typically uses the internet browser program on the client device to access various online stores, browse the product items available at the online stores and electronically purchase the desired product items. The client device in this example illustration is an internet enabled personal computer. In order to add a desired product item to the product item list associated with the user's gift registry account, the gift registrant user uses the internet browser program on the client device to access the web page of the online store that sells the said product, selects the said product's listing on the web page of the online store using a computer mouse or a keyboard and activates the menu item options list available after selecting desired product. Under the present invention, one of the menu item options provided to the user in the said menu item options list is the option “Add to GiftWisdom”. Upon selecting the “Add to GiftWisdom” menu item option, the computer program provided in the embodiment of the present invention determines the pertinent product description information about the selected product item from the web page that contains the selected product item's listing and displays the product information so determined to the user using a computer graphical interface within the context of the internet browser, allowing the user to edit and modify any of the product information details and subsequently transmits the user's registry account information and the product information details so determined to the server computer that hosts the user's gift registry account at GiftWisdom. The specific information items that are parsed for and determined from the web page can be configured by the gift registry service provider to adapt to the features provided by the gift registry service and typically includes details about the selected product item such as its name, selling price, Uniform Resource Locator of the product's photographic image on the web page, special rebate and discount offers available with the purchase of the selected product, etc. The server computer upon receiving the said information uses the registry account information to lookup and access the user specific product item registry from the computer database and adds the product item information to the product item list associated with the said registry.

Alternately, if the online store supports querying of its product item database by third party service providers, then the computer program provided under the embodiment of the present invention determines the selected product item's product identification number or such other unique product identifier and the URL of the online store by parsing the web page of the online store that contains the listing of the said selected product item. The said computer program then opens an internet communication session with a server computer hosted by GiftWisdom registry service provider and transmits the product identifier and the online store's URL information so determined to the said server computer over the said internet communication session. The server computer hosted by GiftWisdom registry service provider uses the received information to access and query one or more computer databases at the online store and determine the pertinent product description information about the selected product item based upon the supplied unique product identifier. The server computer then transmits the pertinent product description information items to the user's client device over the internet communication session that was established from the client device using the computer program under the current invention. Upon receiving the product description information the computer program under the current invention uses a suitable computer graphical interface within the context of the internet browser program to display the received product description information items to the user. In addition this component enables the user to specify additional information such as the product quantity, product size color, etc. and to modify any of the product information items as was determined by the server computer. The computer program under the present invention subsequently transmits the user's registry account information and the product information details so determined to the server computer that hosts the user's gift registry account at GiftWisdom. The server computer upon receiving the said information uses the registry account information to lookup and access the user specific product item registry from the computer database and adds the product item information to the product item list associated with the said registry.

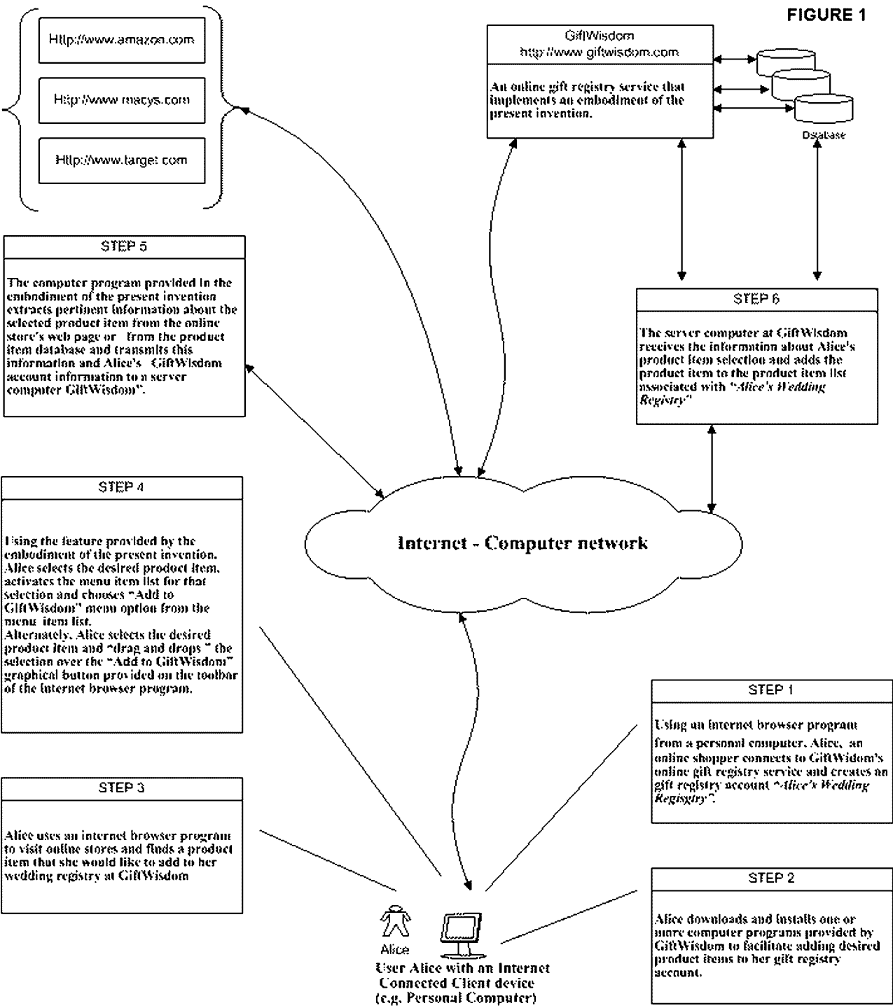

FIG. 3. illustrates the aspect of the present invention that provides an alternate method to allow a gift registrant user to add a desired product item to the product item list associated with the user's online gift registry account. In this figure, the gift registrant user has a gift registry account with “GiftWisdom”, which is an online gift registry service that implements an embodiment of the present invention. After setting up a client device with the necessary software systems as described in FIG. 1, the user typically uses the internet browser program on the client device to access various online stores, browse the product items available at the online stores and electronically purchase the desired product items. The client device in this example illustration is an internet enabled personal computer. In order to add a desired product item to the product item list associated with the user's gift registry account, the gift registrant user uses the internet browser program on the client device to access the web page of the online store that sells the said product, selects the said product's listing on the web page of the online store using a computer mouse, drags the selection over to the custom graphical button with the caption “Add to GiftWisdom” provided on the toolbar of the internet browser program and drops the selection on the said graphical button. When a product item selection is dragged and dropped on the said graphical button in the manner described above, the computer program provided in the embodiment of the present invention extracts the pertinent product description information about the selected product item from the web page that contains the selected product item's listing and transmits this information along with the user's gift registry account information and the URL information of the online store selling the selected product item to the server computer that hosts the user's gift registry account at GiftWisdom.

Alternately, if the online store supports querying of its product item database by third party service providers, then the computer program provided under the embodiment of the present invention determines the selected product item's product identification number or such other unique product identifier and the URL of the online store by parsing the web page of the online store that contains the listing of the said selected product item. The said computer program then opens an internet communication session with a server computer hosted by GiftWisdom registry service provider and transmits the product identifier and the online store's URL information so determined to the said server computer over the said internet communication session. The server computer hosted by GiftWisdom registry service provider uses the received information to access and query one or more computer databases at the online store and determine the pertinent product description information about the selected product item based upon the unique product identifier. The server computer then transmits the pertinent product description information items to the user's client device over the internet communication session that was established by this component, which then uses a suitable computer graphical interface within the context of the internet browser program to display the received product information item to the user. In addition this component enables the user specify additional information such as the product quantity, product size, color, etc. and to modify any of the product information items as was determined by the server computer. The computer program under the present invention subsequently transmits the user's registry account information and the product information details so determined to the server computer that hosts the user's gift registry account at GiftWisdom. The server computer upon receiving the said information uses the registry account information to lookup and access the user specific product item registry from the computer database and adds the product item information to the product item list associated with the said registry.

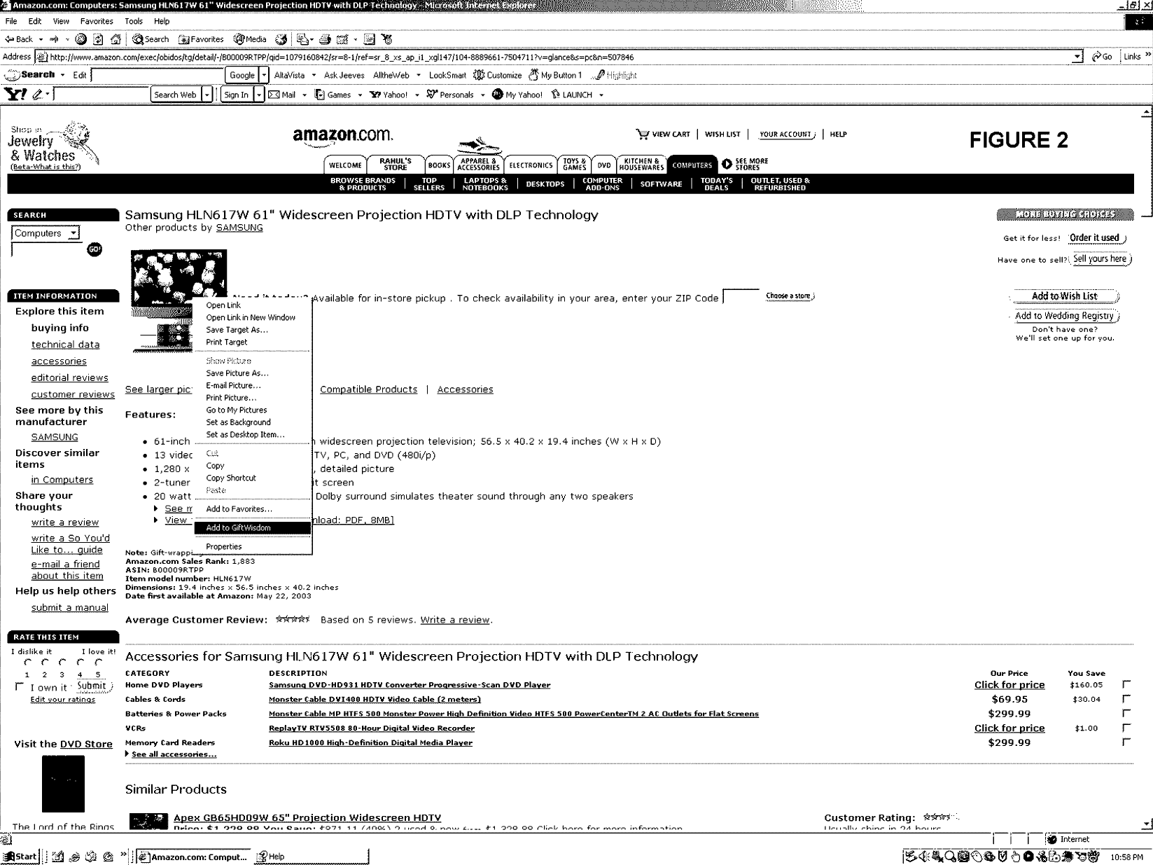

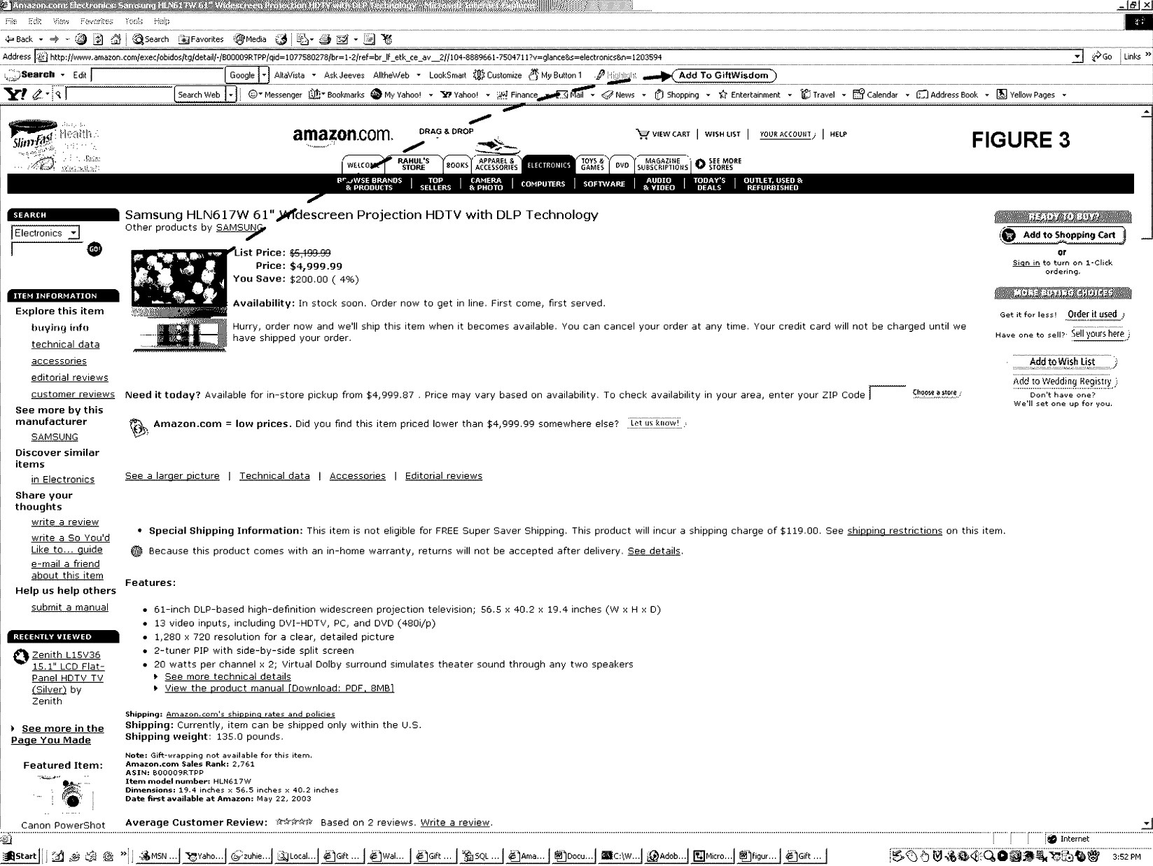

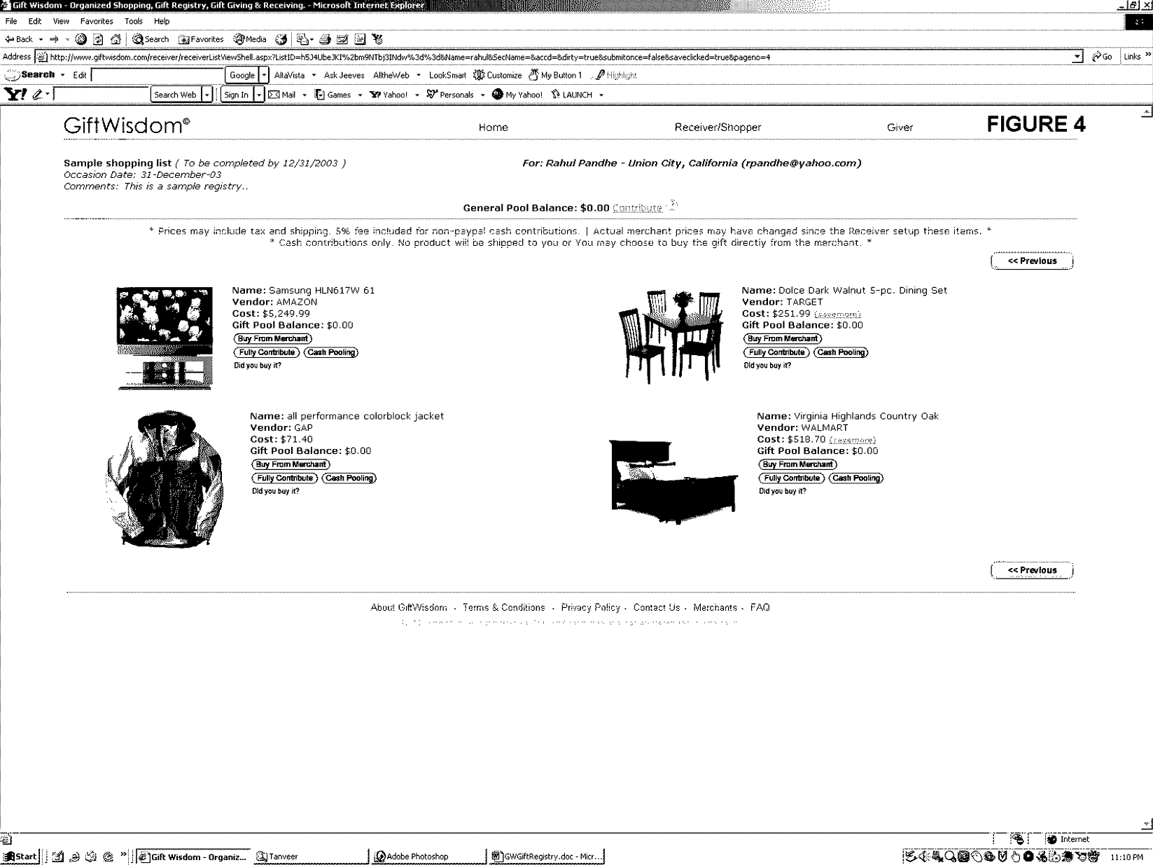

FIG. 4. illustrates the product item list associated with a user's gift registry account hosted by GiftWisdom, which is an online gift registry service that implements an embodiment of the present invention. The gift registry service creates categorized list of product items based upon the user's prior selection of these product items, wherein the pertinent details of user's selection were transmitted from the user's client device to GiftWidom's server computer using the computer program that implements the aspects of present invention as illustrated in FIG. 2.

### DETAILED DESCRIPTION

The present invention is typically applicable in a computer network based electronic commerce system in which a client device connected to the network is used to access shopping stores on the network. Such network based shopping stores are commonly referred to as online stores. Using a client device such as a personal computer, a shopper connects to the online store and fetches information about products available at the store. The present invention defines a method of selecting and determining pertinent product information based upon the shopper's choice of a particular product item. The product information so determined is then transmitted from the client device to a server computer over an electronic computer network such as the internet, where this information is retrievably stored in a computer database and used to build universal product item registries for the shopper. Such universal product item registries can then be used to provide services such as gift registries and wish lists.

The present invention comprises of four distinct components. These components when used together provide convenient methods and a system for online shoppers to select product items from online stores, determine pertinent product description information about the selected product item and add the information so determined to one or more online universal product item registries.

The first component of this invention is a tool that enables an online shopper to specify the product item that he or she would like to add to his or her online universal product item registry. This tool is a computer program designed to work in conjunction with many of the popular internet browser programs. Typically, online shoppers use the internet browser program to gain access to online stores, browse the products available at the online stores and purchase one or more products from the online stores. Under the present invention, whenever the online shopper selects a product item on the web page of an online store and activates the list of menu item options available with that selection, the said tool extends the functionality of the internet browser program by providing the online shopper with a menu item option to add the selected product item to the shopper's universal product item registry. The list of menu item options can be activated by a button on the computer mouse or by a set of one or more keys on the computer's keyboard, or such other input device. In addition, this component provides a mechanism for the online shopper to persistently associate one or more of the shopper's universal product item registry accounts with the shopper's product item selections and manages the shopper's preferences for each of product item registry accounts. Associating a product item selection with a particular registry account or a group of accounts, enables the shopper to add the pertinent details about the selected product item to one or more registry accounts maintained by the shopper. In order to persistently maintain the desired preferences and associations this component stores on the client device the information about the shopper's online product item registry accounts, such as the shopper's name and password used by each such account, the Uniform Resource Locator of the registry account, etc.

The second component of the present invention is a computer program that provides a second method for an online shopper to select a product item from an online store and add the selected product item to his or her online universal product item registry. Under the present invention, the said computer program extends the functionality of the internet browser program by providing a custom graphical button on the toolbar of the internet browser program that provides a set of standard buttons used to navigate the internet. In addition this said component monitors the state of the said button and extracts pertinent product description information whenever a product item is referenced by the said button. A product item is referenced by the said button when an online shopper using such an extended internet browser program visits an online store, selects a desired product item that he or she would like to add to his or her online universal product item registry, drags the selection using a mouse or such other input device and drops the selection on the said custom graphical button provided on the toolbar of the internet browser program. This action is typically known as “drag-and-drop” action in the computer terminology. In addition, this component provides a mechanism for the online shopper to persistently associate one or more of the shopper's universal product item registry accounts with the shopper's product item selections and manages the shopper's preferences for each of product item registry accounts. Associating a product item selection with a particular registry account or a group of accounts, enables the shopper to add the said product item selection to one or more product item registry accounts maintained by the shopper. In order to persistently maintain the desired preferences and associations this component stores information about the shopper's online product item registry accounts, such as the shopper's name and password used by each such account, the Uniform Resource Locator of the registry account, etc.

The third component of this invention is a computer program that determines pertinent product description information about a particular product item when an online shopper using an internet browser program, visits an online store and using the functionality provided by either the first or the second component selects a particular product item and indicates the desire to add the selected product item to his or her online universal product item registry. An online store typically provides information about product items available at the store in blocks of formatted data commonly known as web pages. The data in the web pages are usually represented in one or more information representation languages such as the Hypertext Markup Language (HTML), Wireless Markup Language (WML), Dynamic Hypertext Markup Language (DHTML) or Extensible Markup Language (XML). When an online shopper selects a particular product item at the online store, the said computer program under the third component of the present invention, parses the web page that contains information about the selected product and extracts pertinent description information about that product. Typically, this information consists of one or more of the following data items: (1) Brand name (2) Name of the manufacturer (3) Brief description of the product (4) Selling Price of the product (5) Any discount offers provided by the online retailer with the purchase of the selected product (6) The Uniform Resource Locator (URL) that identifies the unique internet address of the web page that contains information about the selected product (7) The URL of the product's photographic image if the web page contains such an image. (8) The URL of the online store selling the selected product. In addition, this component uses a suitable computer graphical interface within the context of the internet browser program to enable the shopper to specify the quantity desired information of the selected product item and to allow the shopper to verify and change any of the product description information items if so desired, such as the selected product item's description, its size or color information if applicable, etc.

Furthermore, if the online store provides support for querying the store's product item database by third party service providers then the computer program under the present invention determines the selected product item's product identification number or such other unique product identifier and the URL of the online store by parsing the web page of the online store that contains the listing of the said selected product item. This component then opens an internet communication session with a server computer hosted by the registry service provider and transmits the product identifier and the online store's URL information so determined to the said server computer. The server computer hosted by the registry service provider uses the received information to access and query one or more computer databases at the online store and determine the pertinent product description information about the selected product item based upon the unique product identifier. The server computer then transmits the pertinent product information items to the user's client device over the internet communication session that was firstt established by this third component. This third component under the present invention then uses a suitable computer graphical interface within the context of the internet browser program to display the received product information item to the user. In addition this component enables the user specify additional information such as the product quantity, product size, color, etc. and to modify any of the product description information items as was determined by the server computer.

The fourth and final component of the present invention is a computer program that communicates with a remote server computer connected to the internet and transmits the data collected by the earlier components of the present invention. Prior to transmission to the remote server, this component formats the data gathered by the earlier components into a data representation format defined by the mutually agreed upon information exchange protocol between the remote server and the said component. Specifically, this data consists of the following information: (1) The shopper's particular registry account information . that was obtained by the first or the second component, and (2) The pertinent product description data on selected product item and (3) the URL of the online store selling the selected product item that was determined by the third component based upon the shopper's selection of a particular product.

The information exchange protocol between the remote server and this fourth component under the present invention, defines a mutually acceptable data representation format that will be used by the two entities. The said component typically uses standards based internet communication protocol such as Hypertext Transfer Protocol (HTTP) to transmit the data to the remote server computer. In addition, depending upon the communication security preferences of the shopper and the remote server computer, this component can also choose to use secure communication protocols such the Secure Sockets Layer (SSL) protocol or the Secure Hypertext Transfer Protocol (SHTTP). The remote server computer, upon receiving this data typically stores it in a computer database from where this data can then be used to build universal product item registry for the particular shopper.

One embodiment of the present invention when used in an internet based gift registry service enables gift registrants to conveniently add the desired product items to the product item list associated with their gift registry account. A typical internet based gift registry system comprises of a web server system that serves web pages to users who connect to the web server using an internet browser program from a client device such as personal computer connected to the internet. The web server in such a system is connected to one or more computer databases that are used to store the account information and product item lists for registered users of the system.

An internet based gift registry system serves two kinds of entities or users, i.e. gift registrants and gift givers. The gift registrants use the internet based gift registry system to create and retrievably store lists of product items and related information about products that they would like to receive as gift items, selectively view the entries in their product item lists, and add or delete product items and related information from their product item lists. The gift givers use the internet based gift registry system to access and browse the product item lists of a particular gift registrant and engage in electronic commerce interaction such as purchase one or more items described in the product item list for the said gift registrant. To purchase one or more items described in the list, the gift giver selects the uniform resource locator (URL) provided against each of the entries in the product item list using a computer mouse, a keyboard or such other input device, and navigates to the internet site of retailer selling the specified product.

Under the current invention, an internet based gift registry service provider employing the present invention can implement the components of our invention as defined in sections [0017], [0018], [0019], [0020 ] and [2021] as a single computer program or a collection of computer programs and distribute the said programs to its gift registrant users from one or more internet sites, such as from the internet site offering the gift registry service or from the internet sites of popular online retailers. A gift registrant user, registered with the said gift registry service provider will typically download the said computer programs and install these programs on a client device such as an internet connected personal computer. When a gift registrant user accesses an online store using an internet browser program from a client device equipped with the said computer programs that implement the methods and system as described in the present invention, selects a desired product item and activates the menu options list available with that selection, the computer program under the present invention provides the user with a menu item option to add the selected product item to the user's gift registry account. If the user selects the said menu item option, the said computer program under the present invention determines the pertinent product description information about the desired product and displays the product information so determined to the user using a computer graphical interface within the context of the internet browser, allowing the user to edit and modify any of the product information details and subsequently transmits the user's registry account information and the product information details so determined to the server computer operated by the said gift registry service provider. The server computer upon receiving the said information uses the registry account information to lookup and access the user specific product item registry from the computer database and adds the product item information to the product item list associated with the said registry.

In addition the present invention provides an second method of adding a desired product item to the product item list associated with a user's gift registry, wherein the gift registrant user can use the custom graphical button feature provided by the computer program under the present invention to select and add a desired product item to the user's gift registry. In order to use this feature, the user selects the desired product item on the web page of the online store and establishes a reference to the selection by using the computer's mouse device to drag and drop the selection over the custom graphical button provided on the toolbar of the internet browser program. The computer program provided under the present invention that monitors the state of the custom graphical button upon detecting the reference to the selected product item determines the pertinent product description information about the desired product item and displays the product information so determined to the user using a computer graphical interface within the context of the internet browser, allowing the user to edit and modify any of the product information items and subsequently transmits the user's registry account information and the product item information so determined to the server computer operated by the said gift registry service provider. The server computer upon receiving the said information uses the user's registry account information to lookup and access the user specific product item registry from the computer database and adds the product item information to the product item list associated with the said registry.

1. A method of selecting and determining the product item description along with the product item's pricing information and the uniform resource locator (URL) of the photographic image of the product item from the web page of an online store that contains the listing of the said product item, for use in creating one or more user specific product item lists associated with one or more internet based universal product item registry accounts, the said method comprising of the sequence of the following steps:
(i) Using an internet browser program on a client device such as a personal computer connected to the internet, the user navigating to the web page of an online store and selecting a desired product item listing on the said web page with a mouse or a keyboard or such other input device.
(ii) The user activating the internet browser program's menu options list available after selecting the desired product item from the set of one or more product item listings on the web page.

2. The method of claim c1, further comprising the step of providing a menu item option in the internet browser program's menu options list that is available after selecting a desired product item, the said menu item option providing the user with a choice to add the selected product item to the product item list associated with the said user's internet based universal product item registry account such as an online wish list or an online gift registry account.

3. The method of claim c2, further comprising the step of querying the said user for the registry account information such as the said user's account name and security password as registered with the registry service provider that is hosting the said user's universal product item registry and retrievably storing the user provided account information onto the said user's client device such as the personal computer.

4. A second method of selecting and extracting the product item description along with the product item's pricing information and the Uniform Resource Locator (URL) of the photographic image of the product item from the web page of an online store that contains the listing of the said product item, for use in creating one or more user specific product item lists associated with one or more internet based universal product item registry accounts which can be used to provide services such as an online gift registry or an online wish list service. Under this second method, the internet browser program is extended by adding a custom graphical button on the toolbar which contains a set of standard buttons for use in navigating the internet. A computer program associated with the said custom graphical button monitors the state of the button and determines pertinent product information whenever a product item is referenced by the said button. A product item is referenced by the said button when the user selects a product item on the web page of an online store and drags the selection using a mouse or such other input device and drops it over the said button. This action is typically known as “drag-and-drop” action in the computer terminology. This second method comprises of the sequence of following steps:
(i) Using an internet browser program on a client device such as a personal computer connected to the internet, the user navigating to the web page of an online store and selecting a desired product item listing on the said web page with a mouse or such other input device.
(ii) The user dragging the selection using the mouse or such other input device and dropping the selection over the said custom button provided on the toolbar of the internet browser program and thus creating a reference to the product item selection using the custom button.

5. The method of claim c4, further comprising the step of querying the said user for the registry account information such as the said user's account name and security password as registered with the registry service provider that is hosting the said user's universal product item registry and retrievably storing the user provided account information onto the said user's client device such as the personal computer.

6. The methods of claims c3 and c5, based upon the user's selection of the said product item as described in the respective said claims further comprising the step of determining the product item description, selling price, brand name, manufacturer name, the URL of the online store's web page that contains the listing of the said selected product item, the URL of the product's photographic image and the URL of the online store selling the said selected product item, wherein the said determination is performed by parsing the web page of the online store to find the said required information items.

7. The method of claim c6, further comprising the step of querying the user for the quantity information to determine the number of pieces of the selected product item as desired by the user, the said querying performed by using the computer graphical interface within the internet browser context to prompt the user to provide the necessary quantity information and to receive the required information from the user.

8. The method of claim c7, further comprising the step of displaying to the user the information items determined as described in claim c6 and allowing the user to edit or modify any of the said information items, the said display and modification of the said information items performed by using the computer graphical interface within the internet browser context.

9. The method of claim c8, further comprising the step of transmitting the product information items, determined as described in claim c8 and the quantity information determined as described in claim c7 and the said user's registry account information, determined as described in claims c3 and c5, to a server computer connected to one or more computer databases and hosted by the registry service provider.

10. The method of claim c9, wherein the received information at the said server computer consisting of the user's registry account information and said selected product item description information and the product quantity information, further comprising the steps of: the said server computer using the received registry account information to determine and retrieve the user specific product item list from one or more computer databases; adding the received product item information to the said user specific product item list; and retrievably storing the updated product item list in one or more computer databases.

11. The methods of claims c3 and c5, based upon the user's selection of the said product item as described in the respective said claims, further comprising of an alternate method of determining the product item description, selling price, brand name, manufacturer name and the URL of the product's photographic image. The said method comprising of parsing the web page of the online store to determine the product identification number or such other unique product item identifier based upon the user's selection of the said product item.

12. The method of claim c11, further comprising the step of opening an internet communication session from the user's client device to a server computer hosted by the registry service provider and transmitting the unique product item identifier determined as described in the said claim and the URL of the online store selling the said selected product item to the said server computer.

13. The method of claim c12, wherein the received information at the said server computer consisting of the product identification number or such other unique product identifier and the URL of the online store selling the said selected product item, further comprising the steps of: the said server computer using the received product identification number or such other unique product identifier and the URL of the online store selling the said selected product item to access and query one or more computer databases maintained by the online store provider and fetching the information about the said selected product item such as the product item description, selling price, brand name, manufacturer name, and the URL of the product's photographic image; the said server computer transmitting the product item information thus obtained to the user's client device over the internet communication session that was setup by the user's client device as described in claim c12.

14. The method of claim c13, wherein the received information at the user's client device consisting of the product information items transmitted by the server computer as described in claim c13, further comprising the step of: the user's client device displaying to the user the product information items as received from the server computer and determined as described in claim c13, and allowing the user to edit or modify any of the said product information items, the said display and modification of the said information items performed by using the computer graphical interface within the internet browser context.

15. The method of claim c14, further comprising the step of querying the user for the quantity information to determine the number of pieces of the selected product item as desired by the user, the said querying performed by using the computer graphical interface within the internet browser context to prompt the user to provide the necessary quantity information and to receive the required information from the user.

16. The method of claim c15, further comprising the step of transmitting the product information items determined as described in claim c14, and the quantity information determined as described in claim c15 and the said user's registry account information, determined as determined in claims c3 and c5, to a server computer connected to one or more computer databases and hosted by the registry service provider.

17. The method of claim c16, wherein the received information at the said server computer consisting of the user's registry account information, the selected product item description information and the selected product's quantity information, further comprising the steps of: the said server computer using the received registry account information to determine and retrieve the user specific product item list from one or more computer databases; adding the received product item information to the said user specific product item list; and retrievably storing the updated product item list in one or more computer databases.
